(19) United States
(12) Patent Application Publication
(10) Pub. No.: US 2003/0177506 A1
(43) Pub. Date: Sep. 18, 2003

(54) Set top box

(75) Inventor: Ken Wu, Taipei (TW)

Correspondence Address: BACON & THOMAS, PLLC, 625 SLATERS LANE, FOURTH FLOOR, ALEXANDRIA, VA, 22314

(73) Assignee: Kinpo Electronics, Inc., Taipei (TW)

(21) Appl. No.: 10/097,958

(22) Filed: Mar. 15, 2002

(51) Int. Cl. H04N 7/16

(52) U.S. Cl. 725/139; 725/151

(57) ABSTRACT

Set top box including an IR module, a decoder, a reset unit, a super I.O. and a CPU. The IR module serves to receive controlling signal code sent from a remote controller. The controlling code is decoded by the decoder. According to the decoding result, the decoder selectively generates a first decoding signal to control the reset unit to execute reset operation or generate a second decoding signal which is sent through the super I.O. to the CPU to execute screen power-saving operation.

### BACKGROUND OF THE INVENTION

The present invention is related to an improved set top box. In accordance with different lengths of pressing time of a power key of a remote controller, a reset unit executes reset operation or a CPU executes screen power-saving operation.

It is a trend to combine a computer with a domestic electric appliance. Internet televisions have been more and more widely used. An internet viewer is combined with a basic television to achieve functions of television, modem and viewer. This enhances convenience in use and lowers cost for these products as well as saves room.

A set top box is used to combine the controls of various domestic electric appliances. Such set top box must be lastingly or always kept in an activated state to ensure that no control signal input and control operation output is lost. The conventional set top box lacks any power-saving function (such as screen power-saving standby). Therefore, the screen monitor synchronously activated with the set top box is often objectlessly activated when not operating the main frame. An operator must specifically via the switch of the screen turn off the screen monitor. This wastes energy and shortens the using life of the screen monitor. Moreover, the operation location of the screen control measure is fixed so that it is inconvenient for a user to operate.

Furthermore, limited by the stability of computer, microprocessor, etc. and bug of execution of software, the main frame of the computerized domestic electric appliances will inevitably fail or encounter mistake in use. When this happens, a user often shuts off the power and reactivates the main frame to re-execute cold-starting or even via a specific starting procedure to execute reset. This costs longer waiting time and the internal electronic elements of the main frame are likely to damage after repeatedly turned on/off.

### SUMMARY OF THE INVENTION

It is therefore a primary object of the present invention to provide a set top box which controls operation of a screen via a controlling signal. The set top box includes a receiver module for receiving the controlling signal and a decoder for decoding the controlling signal and generating a first decoding signal or a second decoding signal. When the first decoding signal is generated, a reset unit is controlled to execute reset operation. When the second decoding signal is generated, a CPU controls and executes screen power-saving operation. By means of simple structure and convenient operation, the main frame is changeably controlled to execute reset or screen power-saving operation. This enhances convenience in use and saves energy.

The present invention can be best understood through the following description and accompanying drawings wherein:

### BRIEF DESCRIPTION OF THE DRAWINGS

FIG. 1 is a block diagram view of the basic structure of the present invention; and

FIG. 2 is an operation flow chart of the present invention.

### DETAILED DESCRIPTION OF THE PREFERRED EMBODIMENTS

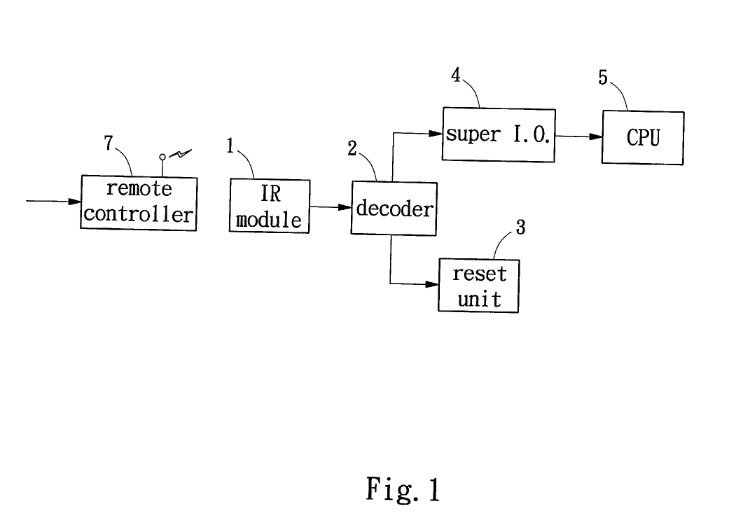

Please refer to FIG. 1. The set top box (STB) present invention includes an IR module 1, a decoder, a reset unit 3, a super I.O. 4 and a CPU 5. The IR module 1 is used to receive controlling signal code sent from a remote controller 7. The controlling code is varied with different lengths (for example, over 5 seconds or shorter than 5 seconds) of pressing time of a power key of the remote controller 7. The controlling code is decoded by the decoder 2. According to the decoding result, in the case that the length of pressing time of the power key is over 5 seconds, the decoder 2 generates a first decoding signal to control the reset unit 3 (which can be an IC) to execute reset operation. Alternatively, in the case that the length of pressing time of power key is shorter than 5 seconds, a second decoding signal is generated and sent through the super I.O. 4 to the CPU 5. The CPU 5 controls not to output video and audio signal and execute power-saving operation of the screen.

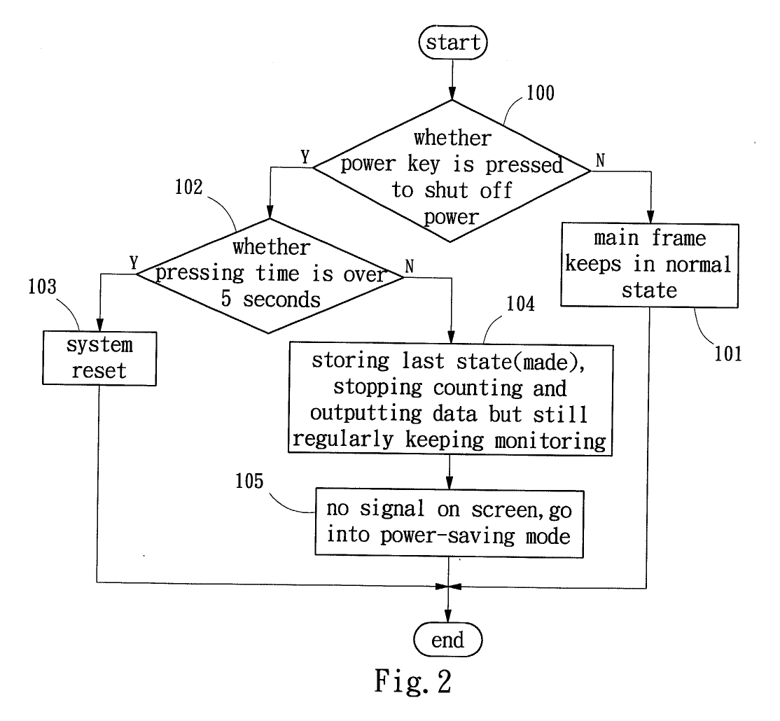

FIG. 2 shows the operation flow chart of the present invention. First, in step 100 “whether power key is pressed to shut off power”, it is judged whether the power key is pressed when the main frame is in general operation state. If no N, the procedure goes to step 101 “the main frame keeps in normal state” and the main frame is ensured to keep in original normal operation state. If yes Y, the procedure goes to step 102 “whether the pressing time is longer than 5 seconds”. If yes Y, step 103 “system reset” is executed to reset the system (reactivation). If no N, through step 104 “storing last state (mode), stopping counting and outputting data but still regularly keeping monitoring”, the procedure goes to step 105 “no signal on the screen, going into power-saving mode”. According to the above procedure, simply by means of pressing the power key, the main frame is changeably controlled to execute reset or screen power-saving operation. This enhances convenience in use and saves energy.

The effective time of pressing of the power key for generating controlling signal code is not limited to 5 seconds. The pressing time can be changed in accordance with actual requirement (for example, over 4 seconds or shorter than 4 seconds).

The above embodiments are only used to illustrate the present invention, not intended to limit the scope thereof. Many modifications of the above embodiments can be made without departing from the spirit of the present invention.

What is claimed is:

1. Set top box for controlling operation of a screen via controlling signal, comprising:
A receiver module for receiving the controlling signal;
a decoder for generating a first decoding signal or a second decoding signal according to the controlling signal;
a reset unit for executing reset operation according to the received first decoding signal; and
a CPU for controlling and executing power-saving operation of the screen according to the received second decoding signal.

2. Set top box as claimed in claim 1, wherein the receiver module is an IR module and the controlling signal is generated by a remote controller.

3. Set top box as claimed in claim 1, wherein the controlling signal is varied with different lengths of pressing time of a press key, the first and second decoding signals being generated in accordance with the controlling signal.

4. Set top box as claimed in claim 3, wherein the press key is a power key.

5. Set top box as claimed in claim 3, wherein in the case that the pressing time is over 5 seconds, the first decoding signal is generated, while in the case that the pressing time is not over 5 seconds, the second decoding signal is generated.

6. Set top box as claimed in claim 1, further comprising a super I.O. between the decoder and the reset unit, serving to provide a buffing effect for the input of the first decoding signal.
